(19) United States
(12) Patent Application Publication
(10) Pub. No.: US 2024/0247707 A1
(43) Pub. Date: Jul. 25, 2024

(54) ELECTRONIC KEY OPERATION DEVICE

(71) Applicant: YOKOWO CO., LTD., Tokyo (JP)

(72) Inventor: Tsugio YAMAMOTO, Tokyo (JP)

(73) Assignee: YOKOWO CO., LTD., Tokyo (JP)

(21) Appl. No.: 18/415,665

(22) Filed: Jan. 18, 2024

(30) Foreign Application Priority Data
Jan. 19, 2023 (JP) 2023-006575

(51) Int. Cl. F16H 21/44; B60R 25/24; G07C 9/00

(52) U.S. Cl. CPC F16H 21/44; B60R 25/24; G07C 9/00944

(57) ABSTRACT

An electronic key operation device according to the present disclosure includes: an accommodation portion configured to accommodate an electronic key; a pressing member configured to press a button of the electronic key accommodated in the accommodation portion; an actuator configured to apply power for pressing the button to the pressing member; and a position setting portion configured to set a relative position between the actuator and the pressing member and set a position of the pressing member. The position setting portion is configured to set a position of the pressing member so as to correspond to a position of the button in a first direction and a second direction intersecting the first direction.

### CROSS-REFERENCE TO RELATED APPLICATION(S)

This application is based on and claims priority under 35 USC 119 from Japanese Patent Application No. 2023-006575 filed on Jan. 19, 2023, the contents of which are incorporated herein by reference.

### TECHNICAL FIELD

The present disclosure relates to an electronic key operation device, and more particularly, to an electronic key operation device for operating an accommodated electronic key from an outside.

### BACKGROUND ART

For example, as a usage form of a vehicle, there is a form in which a plurality of persons share one or a plurality of vehicles. This corresponds to car sharing and rental cars. Hereinafter, such usage forms are collectively referred to as “sharing”.

In sharing, handling of a key for using a vehicle to be shared is important. For example, Patent Literature 1 discloses an electronic key storage case for receiving and delivering an electronic key unattended in sharing. In the invention of Patent Literature 1, a smartphone or the like communicates with a storage case in a vehicle in which an electronic key is stored from outside the vehicle. Further, when a button of the electronic key in the vehicle is operated from outside the vehicle, a door lock of the vehicle is unlocked and the electronic key in the vehicle can be received.

Patent Literatures 2 to 3 also disclose a delivery system of an electronic key for car sharing. Patent Literature 4 discloses an electronic key storage case for antitheft that stores an electronic key in a vehicle.

### CITATION LIST

### Patent Literature

Patent Literature 1: W02021/054404
Patent Literature 2: European Patent Application Publication No. 3912869
Patent Literature 3: JP2019-512630A
Patent Literature 4: JP2021-167151A

In the electronic key storage case described in Patent Literature 1, it is necessary to change an arrangement of a pressing portion pressing a button and an actuator and a shape of a storage space of the electronic key according to the button and an outer shape of the electronic key. Therefore, it is necessary to design and manufacture the storage case according to forms of various electronic keys existing in the world, and/or it is necessary to increase the size of a box body portion of the storage case.

### SUMMARY

Accordingly, an object of the present disclosure is to provide an electronic key operation device that can be used by a minimal design change for various electronic keys and can be reduced in size. Another object of the present disclosure becomes apparent from description of this specification.

In order to solve the above problem, according to an aspect of the present disclosure, there is provided an electronic key operation device including: an accommodation portion configured to accommodate an electronic key; a pressing member configured to press a button of the electronic key accommodated in the accommodation portion; an actuator configured to apply power for pressing the button to the pressing member; and a position setting portion configured to set a relative position between the actuator and the pressing member and set a position of the pressing member so as to correspond to a position of the button. Here, the position setting portion may be configured to set the position of the pressing member in a first direction and a second direction intersecting the first direction.

According to the electronic key operation device of the present disclosure, since the position of the pressing member can be set by the position setting portion while the position of the actuator is fixed, the position of the pressing member and the position of the button of the electronic key can be easily matched. Further, in the position setting portion, the arrangement of the pressing member may be two-dimensionally changed in the first direction and the second direction. Accordingly, the electronic key operation device can be used by a minimal design change for various electronic keys. Further, since it is not necessary to change the position of the actuator according to the position of the button of the electronic key, it is not necessary to change a shape of a box body portion of the electronic key operation device, and it is not necessary to secure a space for changing the position of the actuator inside, so that it is possible to reduce the size.

### BRIEF DESCRIPTION OF DRAWINGS

FIG. 1 illustrates an example of a system configuration of a sharing system.

FIG. 2 conceptually illustrates an operation of an electronic key operation device according to one embodiment.

FIG. 3 conceptually illustrates an X-axis cross section of a structure of the electronic key operation device according to the embodiment.

FIG. 4 conceptually illustrates a Y-axis cross section of the structure of the electronic key operation device according to the embodiment.

FIG. 5A is a perspective view illustrating only an actuator, an intermediate member, and a part of a box body portion of the electronic key operation device.

FIG. 5B is a perspective view illustrating only the intermediate member and a rotation shaft of the electronic key operation device.

FIG. 6A is an exploded view of a pressing member and a position setting portion.

FIG. 6B is an assembly diagram of the pressing member and the position setting portion.

FIG. 7 conceptually illustrates a projection view of an internal structure of the electronic key operation device according to the embodiment onto a plane perpendicular to a Z-axis.

FIG. 8 schematically illustrates a final assembly process of the electronic key operation device.

FIG. 9 illustrates set positions of first and second pressing members in the position setting portion when an unlocking button and a locking button are arranged side by side along a long axis of an electronic key.

FIG. 10 illustrates the set positions of the first and second pressing members in the position setting portion when the unlocking button and the locking button are arranged obliquely with respect to the long axis of the electronic key.

FIG. 11 conceptually illustrates the electronic key when the unlocking button and the locking button are arranged adjacent to each other in a direction perpendicular to the long axis of the electronic key.

FIG. 12 conceptually illustrates a projection view of an internal structure of an electronic key operation device according to one embodiment, in which the unlocking button and the locking button of the electronic key of FIG. 11 can be pressed, onto a plane perpendicular to a Z-axis.

FIG. 13 illustrates set positions of first and second pressing members in a position setting portion according to the embodiment of FIG. 12 when the unlocking button and the locking button of the electronic key of FIG. 11 are pressed.

FIG. 14 illustrates the set positions of the first and second pressing members in the position setting portion according to the embodiment of FIG. 12 when an unlocking button and a locking button of an electronic key different from those of FIG. 13 are pressed.

FIG. 15 illustrates the set positions of the first and second pressing members in the position setting portion according to the embodiment of FIG. 12 when an unlocking button and a locking button of an electronic key different from those of FIG. 13 are pressed.

FIG. 16 illustrates a position setting portion of an electronic key operation device according to another embodiment, and in the embodiment described in FIG. 16, the position setting portion is provided in the intermediate member in the embodiment described in FIG. 3 and the like.

FIG. 17 conceptually illustrates an operation of the electronic key operation device according to the embodiment of FIG. 16.

FIG. 18 conceptually illustrates an operation of an electronic key operation device according to another embodiment.

FIG. 19 illustrates one embodiment in which an electronic key accommodated in an electronic key accommodation case is accommodated in an electronic key accommodation portion of an electronic key operation device.

FIG. 20 schematically illustrates details of the electronic key accommodation case used in the embodiment of FIG. 19 in a state where the electronic key is inserted.

FIG. 21A illustrates a state in which an electronic key accommodation portion is closed in one embodiment in which an electronic key is accommodated in the electronic key accommodation portion of an electronic key operation device without using an electronic key accommodation case.

FIG. 21B illustrates a state in which the electronic key accommodation portion is opened in the embodiment of FIG. 21A.

FIG. 21C illustrates a state in which the electronic key is removed from the electronic key accommodation portion in the embodiment of FIG. 21A.

### DESCRIPTION OF EMBODIMENTS

The present disclosure will be specifically described with reference to the following embodiments, but the present disclosure is not limited thereto. When there is no particular detailed reference to each device, mechanism, means, and the like described in the present specification, those skilled in the art can use known mechanical devices, mechanisms, means, and the like. The respective embodiments can be combined based on ordinary knowledge by those skilled in the art, and configurations not specifically described in the respective embodiments can have the same configurations as the other embodiments or configurations suitable for the embodiments. In a cross-sectional view, a cross section of each member is represented by various oblique lines for easy discrimination from other members, but a difference in oblique lines does not represent a difference in material, shape, or the like of the member. Also in a perspective view, each member is represented by a color or a dot in order to be easily distinguished from other members, but this difference does not represent a difference in material, shape, or the like of the member.

### First Embodiment

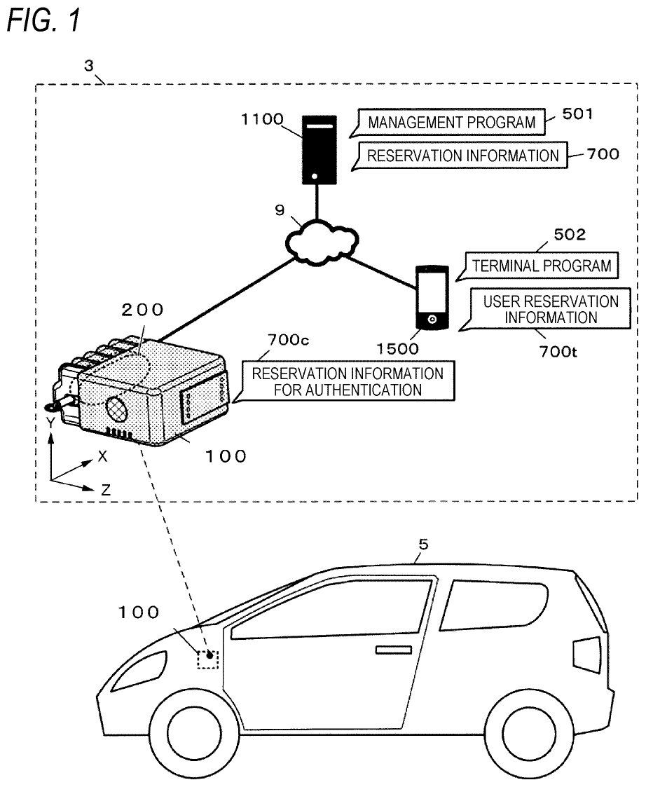

FIG. 1 is a schematic diagram illustrating a system configuration example of a sharing system using an electronic key operation device according to the present disclosure.

A sharing system 3 includes a vehicle 5 to be shared, an electronic key operation device 100 that is an in-vehicle device accommodating a genuine electronic key 200 attached to the vehicle 5, a server system 1100 that performs communication connection with the electronic key operation device 100 via a network 9, and a user terminal 1500 that is used by a user to be shared and performs communication connection with the electronic key operation device 100 via the network 9. One electronic key operation device 100 is mounted on the vehicle 5. In order to actually operate the sharing system 3, one or a plurality of sets of the vehicle 5 and the electronic key operation device 100 are prepared, and a plurality of user terminals 1500 are used.

The electronic key 200 includes an unlocking button and a locking button that are press buttons for unlocking and locking a locking mechanism included in the vehicle 5 to be shared. The electronic key 200 transmits a predetermined unlocking signal when the unlocking button is pressed, and transmits a predetermined locking signal when the locking button is pressed. The network 9 means a communication path through which data communication is possible. A communication method may be wired or wireless.

The server system 1100 performs user registration of the sharing system 3, reservation management, and provision of reservation information to the user terminal 1500 and the electronic key operation device 100. Specifically, by storing and executing a management program 501, the server system 1100 implements (1) a user registration function, (2) a reservation setting function for each vehicle 5, (3) a function of generating reservation information 700 (for example, including a unique reservation ID, a reserved vehicle ID, a reservation period, and a password), (4) a function of providing a copy of the reservation information 700 (reservation information 700t) to the user terminal 1500, and (5) a function of providing the copy of the reservation information 700 (reservation information 700c) to the electronic key operation device 100.

The user terminal 1500 is a computer system connectable to the network 9, which is used by the user, and is realized by, for example, a smartphone, a tablet computer, a notebook computer, a wearable computer, or the like.

The user terminal 1500 can store and execute an application program. As the application program, a terminal program 502 is stored. The terminal program 502 realizes (1) a function of accessing the server system 1100, (2) a function of performing a predetermined unlocking request to the electronic key operation device 100 according to an unlocking operation by a user and providing the reservation information 700t to unlock the electronic key operation device 100, and (3) a function of making a communication connection with the electronic key operation device 100 according to a locking operation by a user to perform a predetermined locking request, and providing the reservation information 700t to lock the electronic key operation device 100.

An arrow indicating a first direction X, a second direction Y, or a third direction Z indicates that a direction from a proximal end to a distal end of the arrow is a positive direction of a direction indicated by the arrow, and a direction from the distal end to the proximal end of the arrow is a negative direction of the direction indicated by the arrow. The first direction X is parallel to an insertion and removal direction of an electronic key accommodation case 300 with respect to the electronic key operation device 100. A positive direction of the first direction X is an insertion direction of the electronic key accommodation case 300. A negative direction of the first direction X is a removal direction of the electronic key accommodation case 300. The second direction Y is orthogonal to the first direction X and parallel to a thickness direction of the electronic key operation device 100. A positive direction of the second direction Y is a direction from below to above the electronic key operation device 100. A negative direction of the second direction Y is a direction from above to below the electronic key operation device 100. The third direction Z is orthogonal to both the first direction X and the second direction Y. The third direction Z is parallel to a depth direction of the electronic key operation device 100. A positive direction of the third direction Z is a direction from a side of the electronic key operation device 100 on which the electronic key accommodation case 300 is attached toward a side opposite to the attachment side. A negative direction of the third direction Z is a direction from the side of the electronic key operation device 100 opposite to the side on which the electronic key accommodation case 300 is attached toward the side on which the electronic key accommodation case 300 is attached. The first direction X, the second direction Y, and the third direction Z in the drawings are also referred to as an X direction, a Y direction, and a Z direction, respectively.

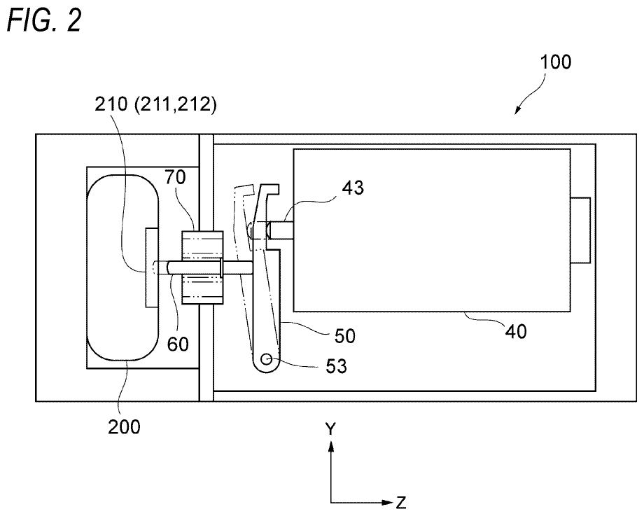

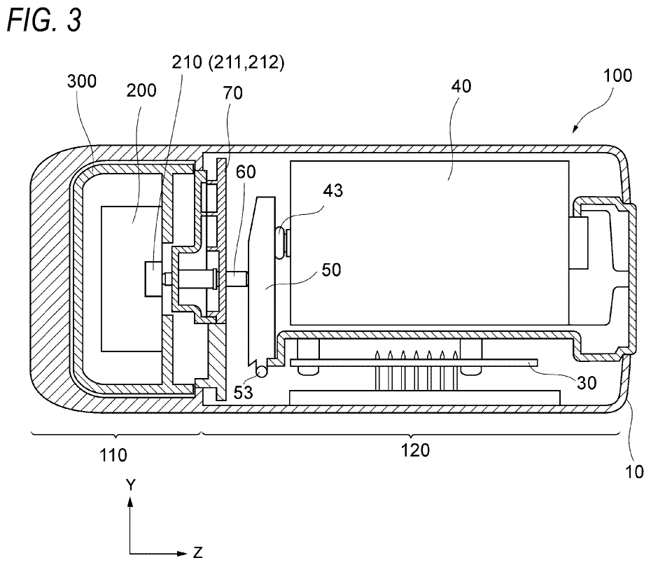

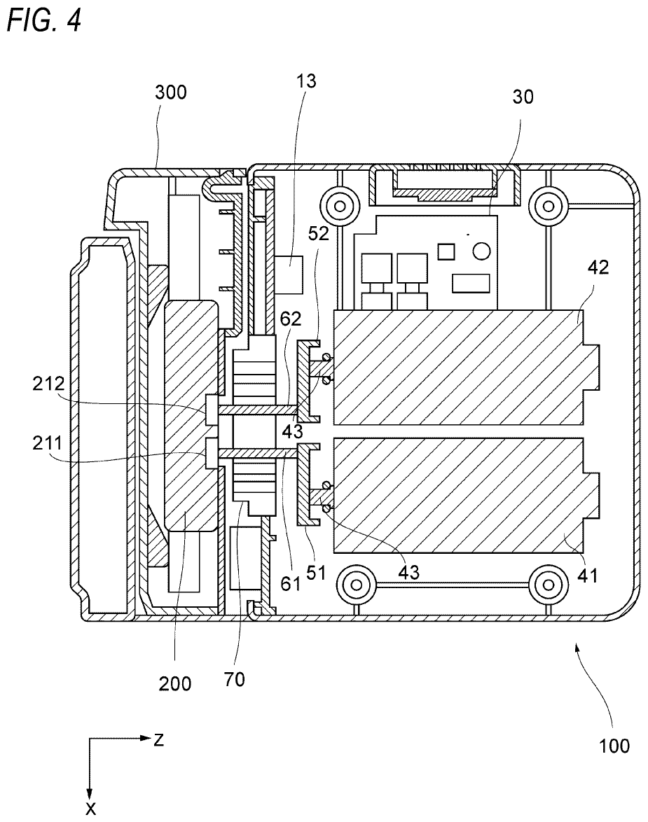

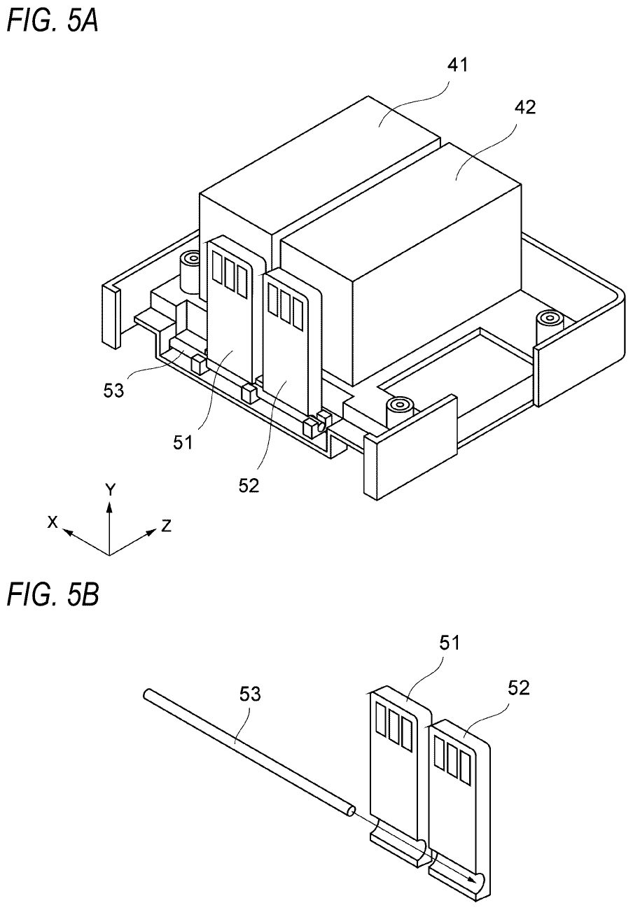

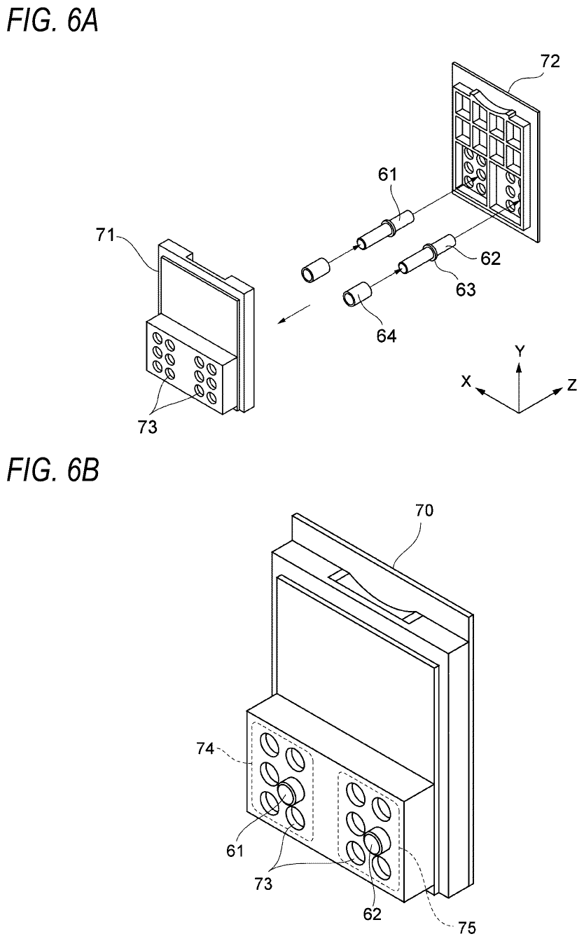

FIG. 2 conceptually illustrates an operation of the electronic key operation device 100 according to a first embodiment. FIGS. 3 and 4 conceptually illustrate a structure of the electronic key operation device 100 according to the first embodiment. FIG. 5A is a perspective view illustrating only the structure of an actuator 40 (hereinafter, referred to as the actuator 40 when first and second actuators 41 and 42 are not distinguished from each other), an intermediate member 50 (hereinafter, referred to as the intermediate member 50 when first and second intermediate members 51 and 52 are not distinguished from each other), and a part of box body portion 10 in the electronic key operation device 100 according to the first embodiment, and FIG. 5B is a perspective view illustrating only the structure of the intermediate member 50 and a rotation shaft 53. In addition, FIG. 6A is an exploded view of a pressing member 60 (hereinafter, referred to as the pressing member 60 when first and second pressing members 61 and 62 are not distinguished from each other) and a position setting portion 70 according to the first embodiment, and FIG. 6B is an assembly diagram thereof.

First, the operation of the electronic key operation device 100 according to the first embodiment will be described with reference to FIG. 2. The electronic key operation device 100 includes the actuator 40, the intermediate member 50 having the rotation shaft 53, the pressing member 60, and the position setting portion 70 that holds the pressing member 60.

The intermediate member 50 to which power is transmitted from the actuator 40 moves around the rotation shaft 53, and can indirectly transmit the power from the actuator 40 to the pressing member 60. The pressing member 60 to which a force is transmitted from the intermediate member 50 can slide in the position setting portion 70 and presses a button 210 of the electronic key 200 (hereinafter, referred to as the button 210 when an unlocking button 211 and a locking button 212 are not distinguished from each other).

After the pressing member 60 presses the button 210 of the electronic key 200 and the power of the actuator 40 stops, the pressing member 60 returns to an original position by a return mechanism and the intermediate member 50 returns to an original position by being pressed by the pressing member 60. A movable portion of the actuator 40 is pushed by the intermediate member 50 and/or can be returned to the original position by another return mechanism.

Next, the structure and function of each component of the first embodiment will be described in detail with reference to FIGS. 3 to 8.

As illustrated in FIG. 3, the electronic key operation device 100 includes an electronic key accommodation portion 110 and an operation mechanism portion 120.

The electronic key accommodation portion 110 accommodates the electronic key 200. The electronic key accommodation portion 110 accommodates the electronic key 200 in a state where the button 210 of the electronic key 200 faces the pressing member 60 side in the operation mechanism portion 120. In the first embodiment, the electronic key 200 is accommodated in the electronic key accommodation portion 110 in a state of being stored in the electronic key accommodation case 300.

The operation mechanism portion 120 is a mechanical structure portion for pressing the button 210 of the electronic key 200, and includes a control unit 30, the actuator 40 that receives a signal from the control unit 30, the intermediate member 50 that receives the power from the actuator 40, and the pressing member 60 that receives the power from the intermediate member 50, in the box body portion 10.

The control unit 30 includes electronic components such as a CPU, an IC memory, a communication module, a power control circuit, an interface IC, and an in-vehicle network communication IC, and/or various circuits, and can integrally control the operation of the electronic key operation device 100. In addition, the electronic key operation device 100 can be connected to the network 9 by the communication module of the control unit 30.

In FIGS. 3 and 4, the control unit 30 is adjacent to the actuator 40 in the Y direction and extends in the X direction and the Z direction, but a position and a direction of the control unit 30 are not particularly limited to those in this embodiment as long as the control unit 30 can exert a function thereof.

The actuator 40 is controlled by the control unit 30 and serves as a driving unit that directly applies the power to the pressing member 60 or indirectly applies the power to the pressing member 60 via the intermediate member 50. Specifically, when an instruction to unlock or lock the electronic key 200 is given to the communication module of the control unit 30 via the network 9, the actuator 40 is controlled by the control unit 30 to push out a movable portion 43.

The actuator 40 may be, for example, an electromagnetic solenoid, specifically, is realized by a push-type linear solenoid, and can push out the rod-shaped movable portion 43 by an electromagnetic force as a drive current flows.

As illustrated in FIG. 4, the actuator 40 includes the first and second actuators 41 and 42, and can press the unlocking button 211 and the locking button 212 by applying the power to the first and second pressing members 61 and 62, respectively. When there are three or more buttons of the electronic key 200 to be operated, three or more actuators 40, three or more intermediate members 50, and three or more pressing members 60 may be provided.

For example, since it may be desired to open a trunk of a vehicle by a remote control using the electronic key operation device and temporarily store a delivered package, a third actuator 40, a third intermediate member 50, and a third pressing member 60 may be provided for a trunk unlocking button of the electronic key 200.

The first and second actuators 41 and 42 are disposed adjacent to each other in the X direction, and can push out the movable portions 43 in the negative direction of the Z direction to transmit the power to the first and second intermediate members 51 and 52.

As illustrated in FIG. 5A, the intermediate member 50 is a member for transmitting the power from the actuator 40 to the pressing member 60. The intermediate member 50 has appropriate rigidity and structure for this purpose. For example, the intermediate member 50 is a rectangular plate-shaped member elongated in the Y direction. The use of the intermediate member 50 makes it easier to freely set the arrangement of the actuator 40, the pressing member 60, and the position setting portion 70, which facilitates size reduction of the electronic key operation device 100. Further, it is easy to appropriately transmit the power from the actuator 40 to the pressing member 60, and it is easy to operate the pressing member 60 perpendicularly to a surface of the button 210 of the electronic key 200.

The intermediate member 50 is not particularly limited as long as it can transmit the power from the actuator 40 to the pressing member 60 and can return to an initial position after transmitting the power to the pressing member 60. For example, the intermediate member 50 may be configured to move back and forth around the rotation shaft 53, or the intermediate member 50 may be configured to be slidable in the box body portion 10.

For example, as illustrated in FIG. 2, the intermediate member 50 can have a plate-like lever shape having the rotation shaft 53. Here, the intermediate member 50 can move so as to fall in the negative direction of the Z direction by receiving the force from the actuator 40. That is, the intermediate member 50 can move in a circumferential direction around the rotation shaft 53 in a YZ plane of the Y direction and the Z direction. Accordingly, the intermediate member 50 transmits the power received from the actuator 40 to the pressing member 60, and the pressing member 60 can operate in the negative direction of the Z direction.

When the intermediate member 50 moves around the rotation shaft 53 as in the first embodiment, a principle of lever can be applied to the power transmitted from the actuator 40 to the pressing member 60. In this case, the power from the movable portion 43 of the actuator 40 can be used as a force point, the rotation shaft 53 can be used as a fulcrum, and the pressing member 60 can be used as a point of action. With the principle of lever, a moving distance of the movable portion 43 of the actuator 40 for pressing the pressing member 60 is increased, but a pressing force required for the movable portion 43 can be reduced. As a result, a small-sized actuator having a small output can be adopted as the actuator 40, and as a result, the electronic key operation device 100 itself can also be reduced in size.

However, the intermediate member 50 does not need to be provided as long as the power can be directly transmitted from the actuator 40 to the pressing member 60. Further, even if the intermediate member 50 is provided, the intermediate member 50 is not necessarily limited to the illustrated embodiment, and may be a member that operates substantially integrally with the movable portion 43 of the actuator 40 or the pressing member 60.

In the first embodiment, the intermediate member 50 includes the first and second intermediate members 51 and 52, and can press the unlocking button 211 and the locking button 212 by applying the power to the first and second pressing members 61 and 62, respectively.

The first and second intermediate members 51 and 52 are disposed adjacent to the movable portions 43 of the first and second actuators 41 and 42 in the Z direction in which the movable portions 43 of the first and second actuators 41 and 42 operate, respectively, and the first and second intermediate members 51 and 52 themselves are disposed adjacent to each other in the X direction.

As illustrated in FIGS. 5A and 5B, each of the first and second intermediate members 51 and 52 has a rod-shaped pin extending in the X direction at a lower portion in the Y direction, and the pin serves as a common rotation shaft 53 of the first and second intermediate members 51 and 52. The pin serving as the rotation shaft 53 needs to have high rigidity, and is preferably a rod-shaped pin made of metal.

As illustrated in FIG. 6A, the pressing member 60 is a member for pressing the button 210 of the electronic key 200, and has an appropriate shape and rigidity for pressing the button 210. The position of the pressing member 60 can be set by the position setting portion 70. The pressing member 60 is a member different from the movable portion 43 of the actuator 40 and can move in parallel with a movable direction of the movable portion 43, but a relative position between the pressing member 60 to the actuator 40 is set by the position setting portion 70, and as a result, the pressing member 60 normally does not move on the same straight line as the movable direction of the movable portion 43. The pressing member 60 may be held so that its position can be changed by the position setting portion 70, or may be held so that its position cannot be changed after the position is set once.

In the first embodiment, the pressing member 60 includes the first and second pressing members 61 and 62. The first and second pressing members 61 and 62 can press the buttons 210 of the electronic key 200 by receiving the power from the first and second intermediate members 51 and 52 and being pushed out in the negative direction of the Z direction. In this embodiment, the first and second pressing members 61 and 62 each have a cylindrical pin structure whose longitudinal direction is the Z direction. Further, in this embodiment, the first and second pressing members 61 and 62 are adjacent to each other in the X direction, but may be adjacent to each other in the Y direction depending on a mode in which the electronic key 200 is held and an arrangement mode of the buttons.

The positions of the first and second pressing members 61 and 62 can be set in the position setting portion 70. Accordingly, the positions of the first and second pressing members 61 and 62 can be set corresponding to the positions of the buttons of various electronic keys.

Specifically, each of the first and second pressing members 61 and 62 is accommodated in one of a plurality of receiving portions 73 of the position setting portion 70. In the first embodiment, the first and second pressing members 61 and 62 are cylindrical pins, and the receiving portions 73 of the position setting portion 70 are circular holes into which the pins can be inserted.

However, the shape of the first and second pressing members 61 and 62 is not limited to that of the first embodiment, and may be an elliptic columnar shape, a polygonal columnar shape, or the like. In addition, the first pressing member 61 and the second pressing member 62 may have different shapes. A shape of the receiving portion 73 can be appropriately changed according to the first and second pressing members 61 and 62.

The first and second pressing members 61 and 62 is slidable in a state of being accommodated in the receiving portion 73, one ends of the first and second pressing members 61 and 62 press the buttons 210 of the electronic key 200, and the other ends thereof receive the power for pressing the buttons 210 from the first and second intermediate members 51 and 52.

By sliding the first and second pressing members 61 and 62 in the position setting portion 70, movement of the pressing members 61 and 62 can be made substantially perpendicular to the buttons 210 of the electronic key 200, and accordingly the buttons 210 can be more reliably pressed.

As illustrated in FIG. 6A, the first and second pressing members 61 and 62 are respectively sandwiched and held by a front portion 71 and a rear portion 72 of the position setting portion 70. In this sandwiched space, the first and second pressing members 61 and 62 each have a flange 63, thereby preventing the first and second pressing members 61 and 62 from coming out of the position setting portion 70.

As illustrated in FIG. 6A, the first and second pressing members 61 and 62 each have a return mechanism 64 formed of, for example, a return spring. The return mechanisms 64 return the first and second pressing members 61 and 62 to their original positions after the buttons 210 of the electronic key 200 are pressed by the power of the actuator 40. In the first embodiment, the return mechanism 64 is sandwiched between a space in the position setting portion 70, in particular, the flange 63 and the front portion 71 of the position setting portion 70.

However, positions of the flange 63 and the return mechanism 64 are not limited to those in the first embodiment. For example, the flange 63 and the return mechanism 64 may be disposed on the positive direction side in the Z direction with respect to the rear portion 72 of the position setting portion 70, or may be disposed on the negative direction side in the Z direction with respect to the front portion 71 of the position setting portion 70. One end of the return mechanism 64 is preferably positioned by the flange 63.

In the first embodiment, the position setting portion 70 includes six receiving portions 73 for setting the position of the pressing member 60 corresponding to each of the first and second pressing members 61 and 62. However, the number of the receiving portions 73 is not limited thereto, and it is sufficient that the receiving portions 73 can correspond to various positions of the buttons of the electronic key.

The position setting portion 70 not only sets the position of the pressing member 60 so as to correspond to the position of the button 210 as described above, but also sets the relative position between the actuator 40 and the pressing member 60. “Set the relative position” means that a positional relationship between the actuator 40 and the pressing member 60 can be changed, and for example, the position setting portion 70 can change the position of the pressing member 60 even when the position of the actuator 40 is fixed.

As described above, the position setting portion 70 can discontinuously change the position of the pressing member 60. With the discontinuous change, a user of the device can easily select the position of the pressing member 60 to be set in the position setting portion 70 with reference to a correspondence table between the position of the button 210 of the electronic key 200 for each vehicle and a setting place of the pressing member 60 in the position setting portion 70.

The position setting portion 70 can have a plurality of discontinuous position setting places for setting the position of the pressing member 60 across the first direction X and the second direction Y. In the first embodiment, there are four position setting places (receiving portions 73) for setting the position of the pressing member 60 in the first direction X and three position setting places in the second direction Y. However, the position setting places are not limited to those in the first embodiment, and for example, two to ten places or three to six places may be provided in each of the first direction X and the second direction Y.

As illustrated in FIG. 6B, the position setting portion 70 according to the first embodiment includes a first portion 74 and a second portion 75 for setting positions of the first and second pressing members 61 and 62, respectively. The position of the first pressing member 61 is set in the first portion 74, the position of the second pressing member 62 is set in the second portion 75, and the first and second pressing members 61 and 62 can press the respective buttons 211 and 212 of the electronic key 200.

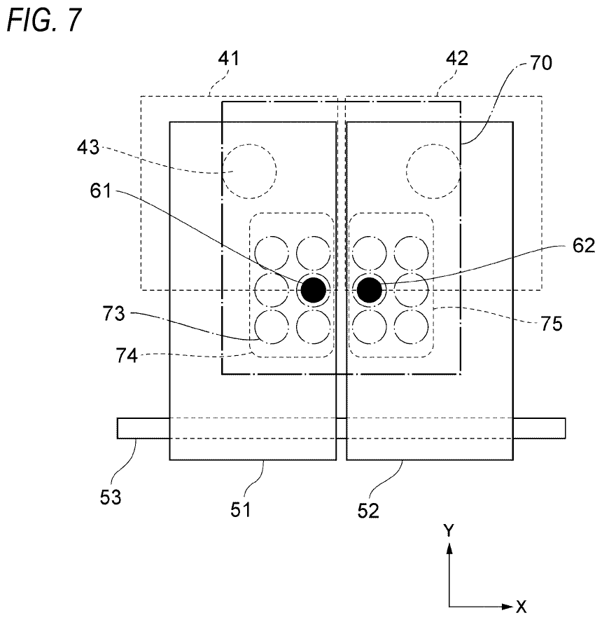

FIG. 7 conceptually illustrates a projection view of the structure of the electronic key operation device according to the embodiment onto a plane perpendicular to a Z-axis. Although only the intermediate members 51 and 52 are illustrated by solid lines, this is to clarify differences from other embodiments to be described later. The first actuator 41 can apply a force to the first intermediate member 51 through the movable portion 43. The first intermediate member 51 to which the force is applied can press the first pressing member 61 positioned in the first portion 74 of the position setting portion 70 by moving in the circumferential direction around the rotation shaft 53. Similarly, the second pressing member 62 can also be pressed through the second actuator 42 and the second intermediate member 52.

The position setting portion 70 is preferably an independent and separate component as in the first embodiment. When the position setting portion 70 is an independent component, the electronic key operation device 100 corresponding to various electronic keys can be manufactured by incorporating only the position setting portion 70 in which the position of the pressing member 60 is set into the electronic key operation device 100. However, the position setting portion 70 may be a part of other constituent members such as the box body portion 10.

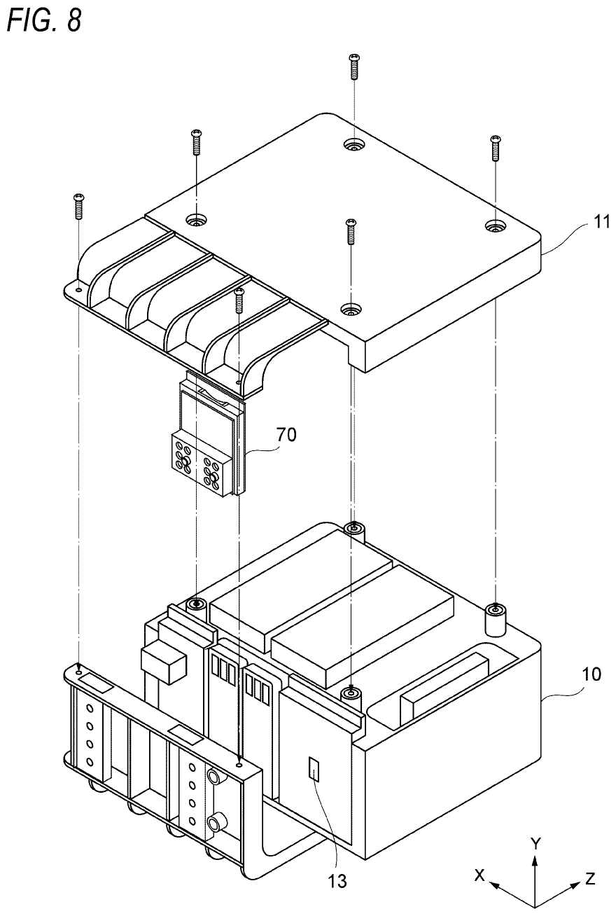

For example, as illustrated in FIG. 8, a portion other than the position setting portion 70 and an upper box body portion 11 of the box body portion 10 is assembled in advance. Here, the electronic key operation device 100 can be completed by assembling the position setting portion 70 in which the position of the pressing member 60 is set and the upper box body portion 11 corresponding to the specific electronic key 200. Since such a final assembling process is very easy, it can be performed by the user.

The configuration of the box body portion 10 is not particularly limited as long as the assembly process is easy and each element is easily accommodated. In addition, for example, in the first embodiment, the box body portion 10 and the upper box body portion 11 are fixed by screws, but any fixing method such as snap fastening or an adhesive can be used.

As illustrated in FIG. 8, the electronic key operation device 100 may include an accommodation detection unit 13 for detecting that the electronic key 200 and/or the electronic key accommodation case 300 is accommodated in the electronic key accommodation portion 110. The accommodation detection unit 13 detects that the electronic key 200 and/or the electronic key accommodation case 300 is accommodated in the electronic key accommodation portion 110, and outputs a detection signal to the control unit 30. The accommodation detection unit 13 may be, for example, a push switch or an optical sensor provided on a side surface of the operation mechanism portion 120 on the negative direction side in the Z direction.

Electric power required for the electronic key operation device 100 may be, for example, supplied from a vehicle side by being connected to an electrical component line of the vehicle, or may be supplied from a built-in battery disposed in the box body portion 10.

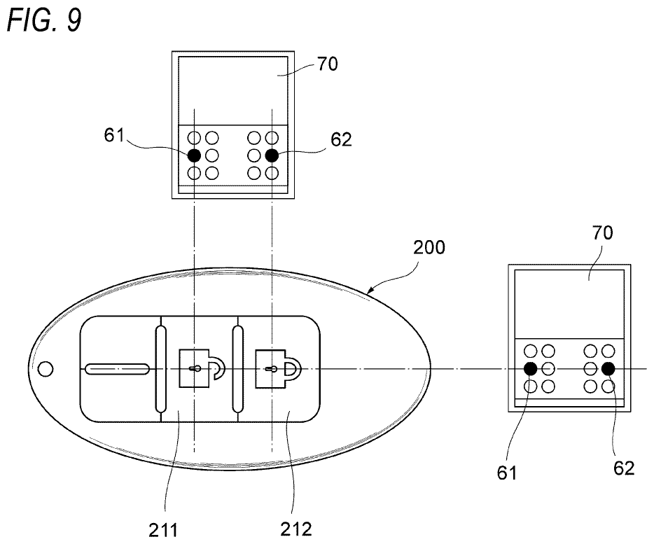

FIG. 9 illustrates set positions of the first and second pressing members 61 and 62 in the position setting portion 70 when the unlocking button 211 and the locking button 212 are arranged side by side along a long axis of the electronic key 200. The position of the first pressing member 61 is set in the position setting portion 70 corresponding to the position of the unlocking button 211, and the position of the second pressing member 62 is set in the position setting portion 70 corresponding to the position of the locking button 212. In the example illustrated in FIG. 9, since the unlocking button 211 and the locking button 212 are arranged side by side along the long axis of the electronic key 200, the positions of the first and second pressing members 61 and 62 are also set in parallel with the long axis of the electronic key 200 correspondingly.

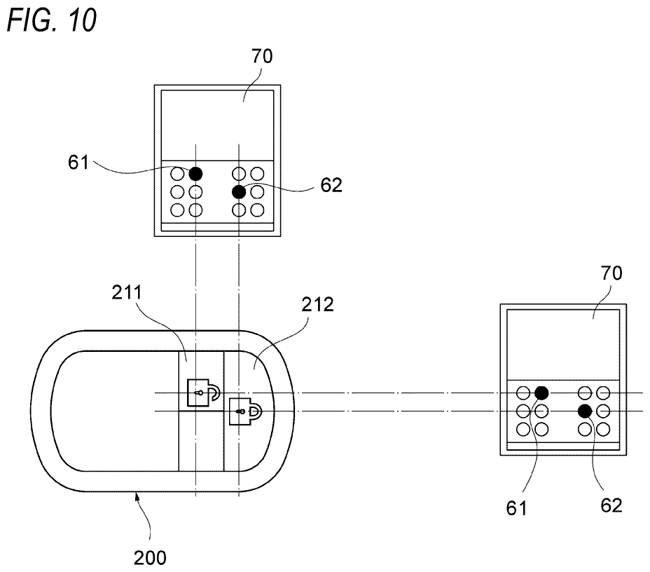

In contrast to FIG. 9, FIG. 10 illustrates the set positions of the first and second pressing members 61 and 62 in the position setting portion 70 when the unlocking button 211 and the locking button 212 are arranged obliquely with respect to the long axis of the electronic key 200. In the example illustrated in FIG. 10, the positions of the first and second pressing members 61 and 62 are also set in an oblique relationship with the long axis of the electronic key 200 corresponding to the positions of the unlocking button 211 and the locking button 212.

As described above, even when the unlocking button 211 and the locking button 212 of the electronic key 200 have various positional relationships, the electronic key operation device 100 can easily correspond to a specific electronic key 200 only by setting the position of the pressing member 60.

### Second Embodiment

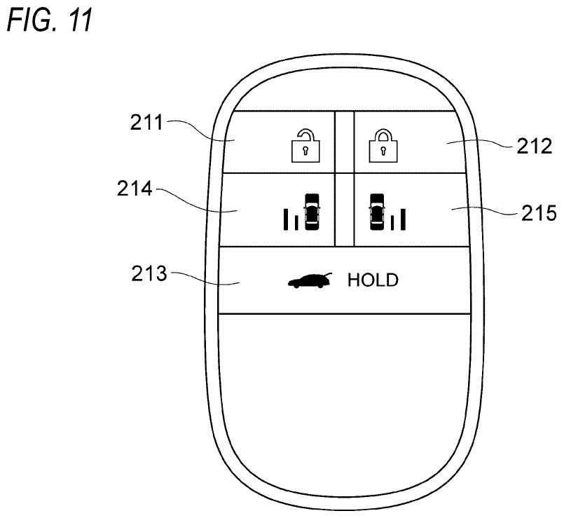

In the first embodiment, as illustrated in FIGS. 9 and 10, the unlocking button 211 and the locking button 212 may be arranged along the long axis of the electronic key 200 or may be arranged obliquely. However, it is difficult to cope with a case where the unlocking button 211 and the locking button 212 are arranged side by side in a short-axis direction of the electronic key 200 as illustrated in FIG. 11.

In recent years, the electronic key 200 tends to have various functions, and for example, the electronic key 200 of FIG. 11 has buttons other than the unlocking button 211 and the locking button 212. Specifically, an opening and closing button 213 of the trunk and opening and closing buttons 214 and 215 of left and right slide doors are provided. When the number of buttons disposed on the electronic key 200 increases, the unlocking button 211 and the locking button 212 may be arranged side by side in the short-axis direction of the electronic key 200 as illustrated in FIG. 11.

In a case where the electronic key 200 of FIG. 11 is temporarily made to correspond to the first embodiment, for example, when the electronic key 200 is inserted into the electronic key accommodation portion 110 in a state where the long axis of the electronic key 200 is parallel to the Y direction (a state where the unlocking button 211 and the locking button 212 are arranged side by side in the X direction), the electronic key 200 can also correspond to the first embodiment. However, in this case, the size of the entire device, particularly in the Y direction, becomes large. Since the electronic key operation device 100 is usually used in a limited space such as a dashboard, it is very important to reduce the size of the entire device.

A second embodiment described below can solve the problem of the first embodiment described above. The second embodiment is the same as the first embodiment except for the following points.

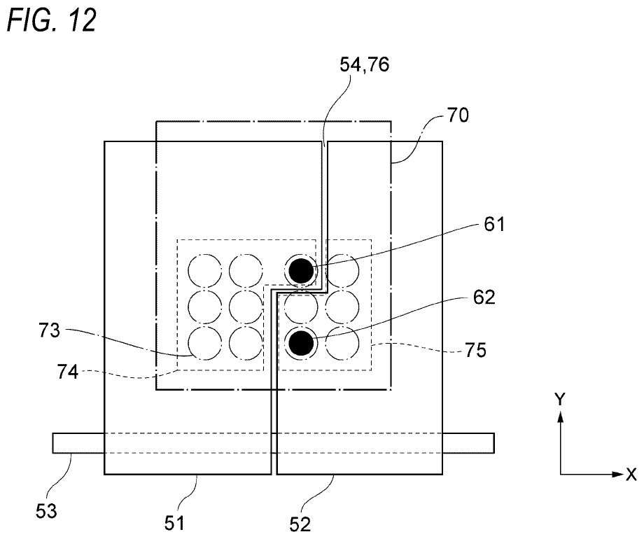

FIG. 12 conceptually illustrates a projection view of the second embodiment onto the plane perpendicular to the Z-axis. As illustrated in FIG. 12, in the second embodiment, the first and second portions 74 and 75 of the position setting portion 70 are adjacent to each other in both the first direction X and the second direction Y. Accordingly, the first and second intermediate members 51 and 52 are also preferably adjacent to each other in both the first direction X and the second direction Y. According to the second embodiment, it is possible to correspond to the button arrangement of the electronic key 200 as illustrated in FIG. 11. In recent years, since the number of buttons of the electronic key tends to increase, such a second embodiment is very suitable.

Specifically, in the second embodiment, since the first intermediate member 51 and the second intermediate member 52 are adjacent not only in the first direction X but also in the second direction Y, the first pressing member 61 and the second pressing member 62 can be set at positions adjacent to each other in the second direction Y of the position setting portion 70. Accordingly, when a force is applied to the first intermediate member 51, the first pressing member 61 is pressed, and the unlocking button 211 of the electronic key 200 as illustrated in FIG. 11 can be pressed, and when a force is applied to the second intermediate member 52, the second pressing member 62 is pressed, and the locking button 212 thereof can be pressed. Accordingly, it is possible to cope with a case where the unlocking button 211 and the locking button 212 are arranged side by side in the short-axis direction of the electronic key 200 as illustrated in FIG. 11.

In the second embodiment, the first intermediate member 51 and the second intermediate member 52 are adjacent to each other in both the first direction X and the second direction Y, but in the case of the embodiment in which the intermediate member 50 is not provided, the first and second portions 74 and 75 of the position setting portion 70 may be adjacent to each other, and the positions of the first pressing member 61 and the second pressing member 62 may be set in the first and second portions 74 and 75, respectively. The shapes of the first and second portions 74 and 75 in this case may be similar to those of the first and second intermediate members 51 and 52. Further, the power may be directly transmitted from the first and second actuators 41 and 42 to the first and second pressing members 61 and 62.

In the second embodiment, boundaries 54 and 76 separating the adjacent portions of the first and second intermediate members 51 and 52 and/or the first and second portions 74 and 75 of the position setting portion 70 are not particularly limited in shape, width, and the like as long as the first and second intermediate members 51 and 52 and/or the first and second portions 74 and 75 of the position setting portion 70 are adjacent to each other in both the first direction X and the second direction Y and the unlocking button 211 and the locking button 212 arranged side by side in the short-axis direction of the electronic key 200 are pressed. The adjacent portions are separated by the boundaries 54 and 76, and the boundaries 54 and 76 can be set to pass between the unlocking button 211 and the locking button 212 arranged side by side in the short-axis direction of the electronic key 200. In addition, the boundaries 54 and 76 may have a two-dimensional shape, for example, a zigzag shape, an S shape, a Z shape, or the like, instead of a one-dimensional linear shape, at the position setting places (the receiving portions 73) of the pressing members 60 that are two-dimensionally and discontinuously disposed in the position setting portion 70.

As illustrated in FIG. 12, the first and second intermediate members 51 and 52 are shaped to be combined with each other with the boundary 54 interposed therebetween, and the size of the boundary is small in the vicinity of the position setting place of the position setting portion 70. Preferably, the first and second intermediate members 51 and 52 may have two substantially L-shaped or stepped shapes as illustrated in FIG. 12.

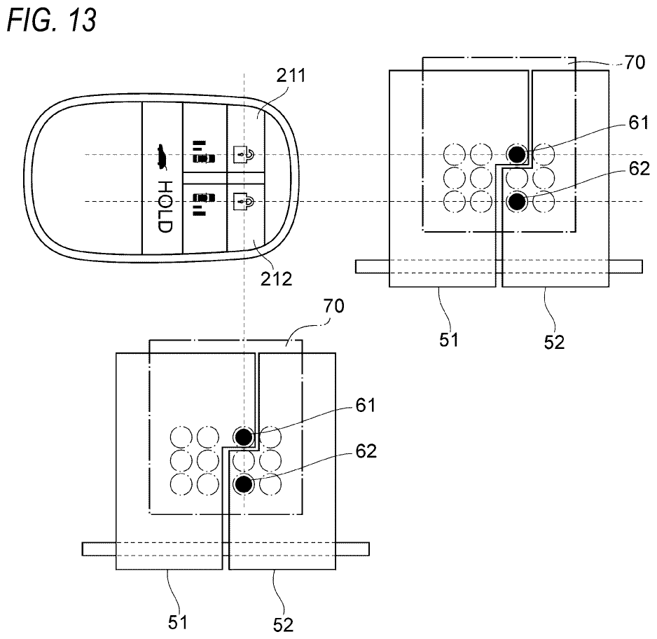

FIG. 13 illustrates the set positions of the first and second pressing members 61 and 62 in the position setting portion 70 according to the second embodiment when the unlocking button 211 and the locking button 212 are arranged side by side along a short axis of the electronic key 200. The position of the first pressing member 61 is set in the position setting portion 70 corresponding to the position of the unlocking button 211, and the position of the second pressing member 62 set adjacent to the first pressing member 61 on a Y axis is set to the position of the locking button 212.

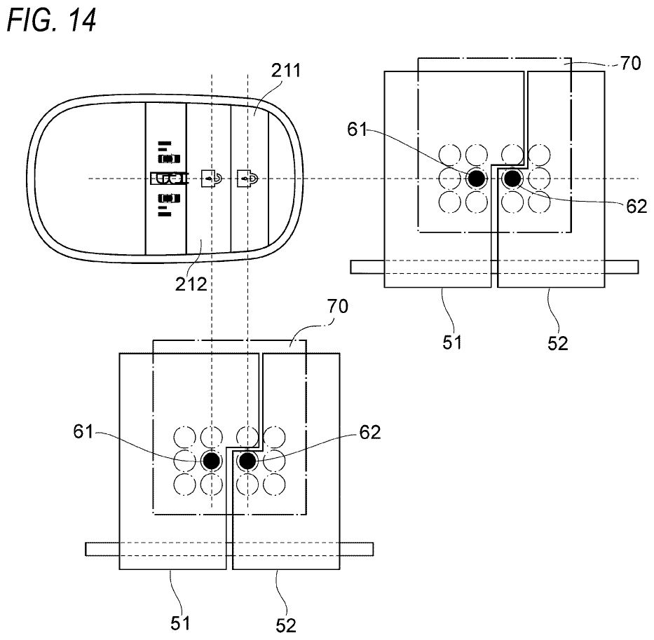

FIG. 14 illustrates the set positions of the first and second pressing members 61 and 62 in the position setting portion 70 according to the second embodiment when the unlocking button 211 and the locking button 212 are arranged side by side along the long axis of the electronic key 200. As illustrated in FIG. 9, the electronic key 200 can be applied to the electronic key operation device according to the first embodiment, but can be applied to the electronic key operation device according to the second embodiment.

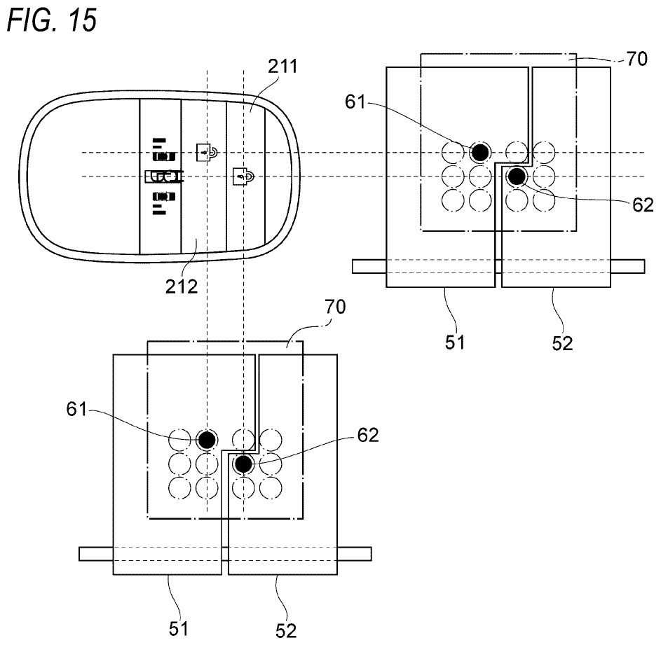

FIG. 15 illustrates the set positions of the first and second pressing members 61 and 62 in the position setting portion 70 according to the second embodiment when the unlocking button 211 and the locking button 212 are arranged obliquely to the long axis of the electronic key 200. As illustrated in FIG. 10, the electronic key 200 can be applied to the electronic key operation device according to the first embodiment, but can be applied to the electronic key operation device according to the second embodiment.

In order to reduce the overall size of the electronic key operation device 100, a degree of freedom in changing the position of the electronic key 200 in the electronic key accommodation portion 110 can be relatively large in a long-axis direction of the electronic key 200, whereas the degree of freedom is often small in the short-axis direction. Under such circumstances, the provision of the position setting portion 70 and/or the intermediate member 50 as in the second embodiment is advantageous to cope with very various electronic keys 200. Within the scope studied by the present inventors, all the electronic keys 200 of commercially available vehicles can be supported by the electronic key operation device 100 according to the second embodiment.

### Third Embodiment

A third embodiment relates to as aspect in which the position setting portion 70 is provided in the intermediate member 50. The third embodiment can also be said to be a case where the intermediate member 50 in the first embodiment is not provided.

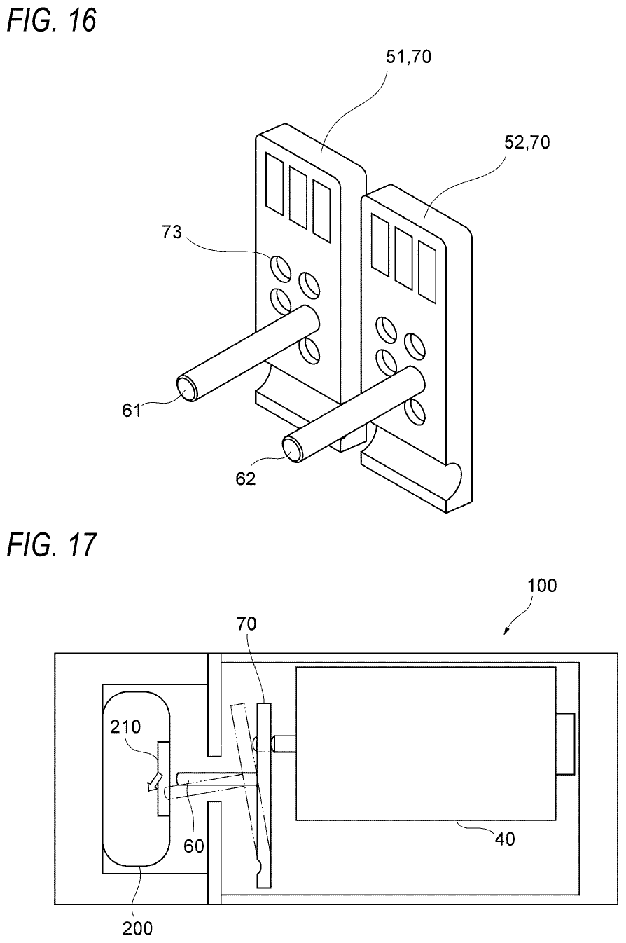

FIG. 16 specifically illustrates the third embodiment. In the third embodiment, the first and second intermediate members 51 and 52 includes a plurality of receiving portions 73 for the first and second pressing members 61 and 62, respectively, and the first and second intermediate members 51 and 52 include the position setting portion 70. In such an embodiment, although the final assembly process is somewhat complicated as illustrated in FIG. 8, there is an advantage that the number of components can be reduced, which is useful.

In the third embodiment, the first and second pressing members 61 and 62 are fixed by the position setting portion 70, and when the first and second intermediate members 51 and 52 having the position setting portion 70 operate, the first and second pressing members 61 and 62 also move together.

However, in the third embodiment, the pressing member 60 is supported only on one side. Therefore, as illustrated in FIG. 17, when the power is transmitted from the actuator 40 and the pressing member 60 is about to press the button 210 of the electronic key 200, a force may not be applied perpendicularly to the button 210. This is because, when the electronic key operation device 100 includes various switches and sensors, a distance from the actuator 40 to the electronic key 200 increases, and thus it is particularly difficult to perpendicularly press the button 210 with the pressing member 60.

On the other hand, in the first embodiment, the pressing member 60 can normally and substantially perpendicularly press the button 210 of the electronic key 200, and therefore the first embodiment is preferable from such a point of view.

### Fourth Embodiment

A fourth embodiment relates to an aspect in which the position setting portion 70 is provided in the actuator 40.

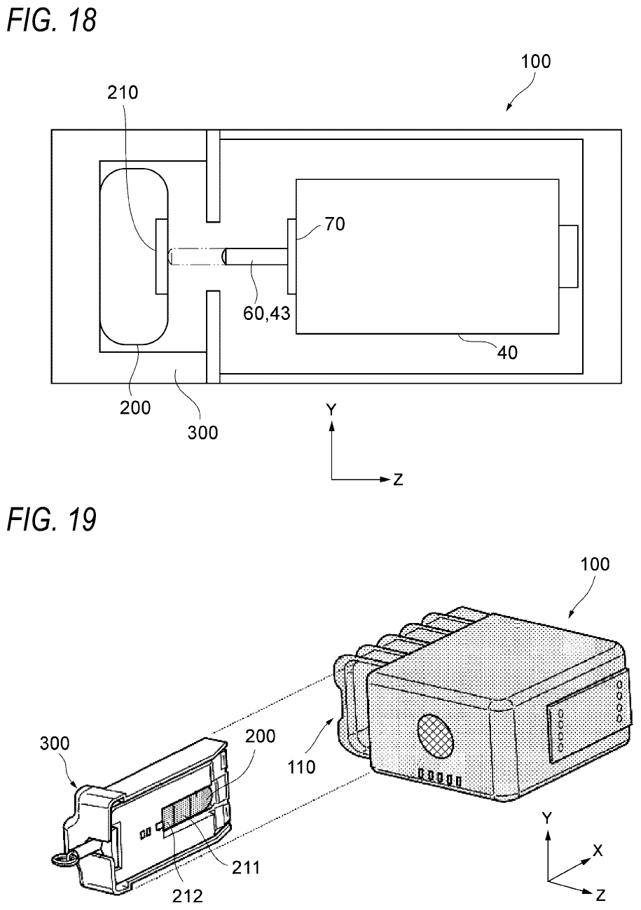

FIG. 18 specifically illustrates the fourth embodiment. In a case of the fourth embodiment, the position setting portion 70 is provided as a part of the actuator 40 or as an independent component disposed in the actuator 40. The pressing member 60 may move together with the position setting portion 70 in a state where the position setting portion 70, as an independent component, is pressed by the movable portion 43 and the pressing member 60 is held by the position setting portion 70, or the intermediate member 50 for applying a force from the movable portion 43 to the pressing member 60 may be provided. In addition, the movable portion 43 of the actuator 40 may function as the pressing member 60. The movable portion 43 whose position is set by the position setting portion 70 directly presses the button 210 of the electronic key 200.

In the fourth embodiment, the number of components can be reduced, which is preferable in that a force can be easily applied perpendicularly to the button 210 compared to the third embodiment. However, since the adjustment of the positional relationship among the position setting portion 70, the movable portion 43 of the actuator 40 that functions as the pressing member 60, and the button 210 of the electronic key 200 is complicated, it can be said that the first embodiment is preferable from the viewpoint of designability, versatility, and the like.

### Fifth Embodiment

A fifth embodiment relates to an aspect in which the electronic key 200 is accommodated in the electronic key accommodation portion 110 of the electronic key operation device 100.

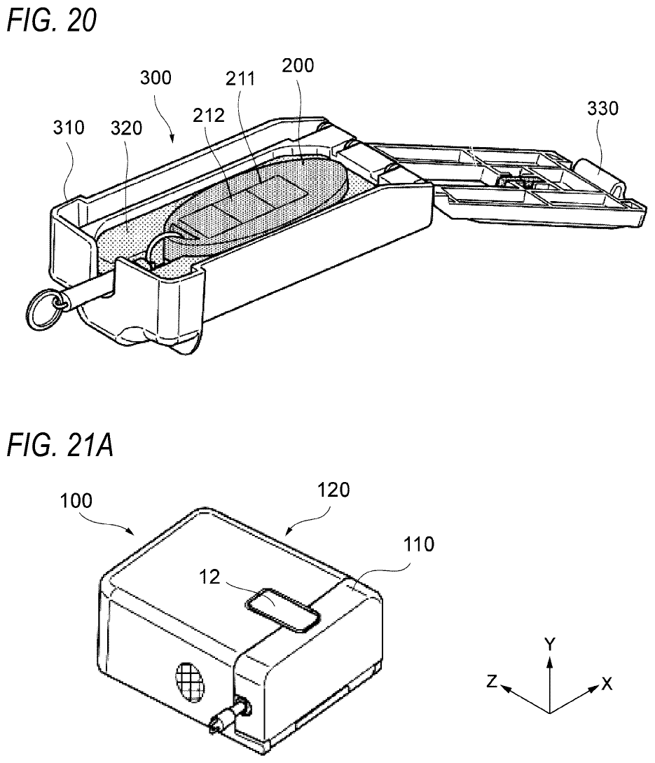

FIGS. 19 and 20 specifically illustrate the fifth embodiment. In the fifth embodiment, the electronic key 200 is inserted into the electronic key accommodation portion 110 while being stored in the electronic key accommodation case 300.

As illustrated in FIG. 20, the electronic key accommodation case 300 has an opening in a part thereof, includes a storage portion 310 for storing the electronic key 200, a key fitter 320, and a lid portion 330 for opening and closing the opening of the storage portion 310, and stores the electronic key 200 in a removable manner. When the electronic key accommodation case 300 stores the electronic key 200 in a state where the unlocking button 211 and the locking button 212 of the electronic key 200 are exposed, and the electronic key accommodation case 300 is accommodated in the electronic key accommodation portion 110, the pressing member 60 presses each of the unlocking button 211 and the locking button 212.

The key fitter 320 can have a shape corresponding to an outer shape of the electronic key 200. For example, the key fitter 320 may be a member formed of a hard sponge or the like in which an accommodation range of the electronic key 200 is hollowed out along the outer shape. The key fitter 320 positions the electronic key 200 so that the unlocking button 211 and the locking button 212 of the electronic key 200 are positioned at predetermined positions in the storage portion 310. The key fitter 320 is selected and used according to a type of the electronic key 200 of the vehicle to which the electronic key operation device 100 is attached.

### Sixth Embodiment

A sixth embodiment relates to an aspect in which the electronic key 200 is directly accommodated in the electronic key accommodation portion 110 of the electronic key operation device 100.

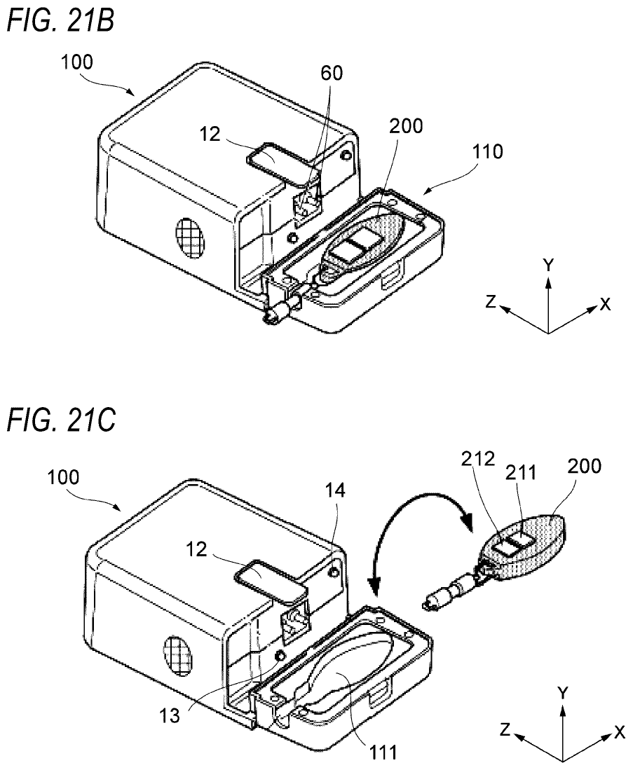

FIGS. 21A to 21C specifically illustrate the sixth embodiment. In the sixth embodiment, the electronic key 200 is directly stored in the openable and closable electronic key accommodation portion 110.

In the sixth embodiment, the electronic key accommodation portion 110 can be opened and closed by swinging with respect to the operation mechanism portion 120. When an opening and closing operation portion 12 provided on the upper box body portion 11 is operated, the connection between the upper box body portion 11 and the electronic key accommodation portion 110 is released, the electronic key accommodation portion 110 becomes openable and closable, and is changed from a closed state illustrated in FIG. 21A to an open state illustrated in FIG. 21B. In the open state, the electronic key accommodation portion 110 opens to a posture in which the accommodated electronic key 200 is exposed upward.

An accommodation recess 111 is formed in the electronic key accommodation portion 110. The accommodation recess 111 accommodates the electronic key 200 with the unlocking button 211 or the locking button 212 facing upward.

Also in this embodiment, the electronic key operation device 100 can include the accommodation detection unit 13 for detecting that the electronic key 200 is accommodated in the electronic key accommodation portion 110. In the sixth embodiment, the accommodation detection unit 13 can detect that the electronic key 200 is accommodated in the electronic key accommodation portion 110 in the closed state and output the detection signal to the control unit 30.

The electronic key operation device 100 can include an opening and closing detection unit 14 of the openable and closable electronic key accommodation portion 110. The opening and closing detection unit 14 detects the open state and the closed state of the electronic key accommodation portion 110 and outputs the detection signal to the control unit 30. The opening and closing detection unit 14 may be, for example, a push switch provided on a side surface of the operation mechanism portion 120 on the negative direction side in the Z direction.

### Seventh Embodiment

In a seventh embodiment, the electronic key operation device 100 is a device for operating an electronic key other than an electronic key of a vehicle, for example, a smart lock for residence. The electronic key operation device 100 is useful in general applications in which electronic key delivery becomes a security problem.

According to the present specification, an electronic key operation device according to the following aspect is provided.

### Aspect 1

An electronic key operation device according to Aspect 1 includes: an accommodation portion configured to accommodate an electronic key; a pressing member configured to press a button of the electronic key accommodated in the accommodation portion; an actuator configured to apply power for pressing the button to the pressing member; and a position setting portion configured to set a relative position between the actuator and the pressing member, in which the position setting portion is configured to set a position of the pressing member so as to correspond to a position of the button in a first direction and a second direction intersecting the first direction.

According to the above aspect, in the electronic key operation device, since the position of the pressing member can be set by the position setting portion while the position of the actuator is fixed, the position of the pressing member and the position of the button of the electronic key can be easily matched. Accordingly, the electronic key operation device can be used by a minimal design change for various electronic keys. Further, since it is not necessary to change the position of the actuator according to the position of the button of the electronic key, it is not necessary to change a shape of a box body portion of the electronic key operation device, and it is not necessary to secure a space for changing the position of the actuator inside, so that it is possible to reduce the size.

### Aspect 2

In the electronic key operation device according to Aspect 2, the position setting portion includes a plurality of receiving portions for accommodating the pressing member.

According to the above aspect, it is not necessary to finely adjust the position of the pressing member, and the position of the pressing member may be set at any one of a plurality of positions of the position setting portion. Accordingly, if it is grasped in advance at which position of the position setting portion the pressing member is to be set for an electronic key of a specific vehicle type, the position of the pressing member can be set very easily.

### Aspect 3

In the electronic key operation device according to Aspect 3, the pressing member is slidable in the receiving portion of the position setting portion, the button is capable of being pressed at one end of the pressing member, and the power for pressing the button is applied at another end thereof.

According to the above aspect, the pressing member can be substantially perpendicular to the button of the electronic key, and the button can be more reliably pressed.

### Aspect 4

In the electronic key operation device according to Aspect 4, at least two pressing members are provided, and the position setting portion includes at least a first portion and a second portion for setting positions of the pressing members, respectively.

According to the above aspect, two or more buttons of the electronic key can be pressed.

### Aspect 5

In the electronic key operation device according to Aspect 5, the first portion and the second portion of the position setting portion are adjacent to each other in both the first direction and the second direction.

According to the above aspect, it is possible to cope with very various electronic keys.

### Aspect 6

The electronic key operation device according to Aspect 6 further includes an intermediate member for transmitting the power from the actuator to the pressing member.

According to the above aspect, the arrangement of the actuator, the pressing member, and the position setting portion can be easily set freely, which facilitates the size reduction of the electronic key operation device.

### Aspect 7

In the electronic key operation device according to Aspect 7, the intermediate member includes a rotation shaft, and the power from the actuator is transmitted to the pressing member by movement of the intermediate member in a circumferential direction.

According to the above aspect, the principle of lever can be applied to the power transmitted from the actuator to the pressing member. The principle of lever works to reduce a pressing force required for a movable portion. As a result, a small-sized actuator having a small output can be adopted as the actuator, and as a result, the electronic key operation device itself can be reduced in size.

### Aspect 8

The electronic key operation device according to Aspect 8 further includes an intermediate member for transmitting power from the actuator to the pressing member, and the intermediate member is divided into a first intermediate member and a second intermediate member corresponding to the first portion and the second portion of the position setting portion.

According to the above aspect, not only two or more buttons of the electronic key can be pressed, but also the arrangement of the actuator, the pressing member, and the position setting portion can be easily set freely, which facilitates the size reduction of the electronic key operation device.

### Aspect 9

In the electronic key operation device according to Aspect 9, the first intermediate member and the second intermediate member are adjacent to each other in both the first direction and the second direction.

According to the above aspect, it is possible not only to possible to cope with very various electronic keys, but also to easily and freely set the arrangement of the actuator, the pressing member, and the position setting portion, which facilitates the size reduction of the electronic key operation device.

### Aspect 10

In the electronic key operation device according to Aspect 10, the position setting portion is a member separate from the intermediate member.

According to the above aspect, the electronic key operation device can be easily manufactured by incorporating only the position setting portion, in a state where the position of the pressing member is set, into the electronic key operation device.

### Aspect 11

In the electronic key operation device according to Aspect 11, the electronic key is accommodated in the accommodation portion in a state of being fixed by an electronic key accommodation case.

According to the above aspect, if only the design of the electronic key accommodation case is changed in accordance with the shape of the electronic key, it is not necessary to change the design of the electronic key operation device, which is useful.

### Aspect 12

An electronic key operation device according to Aspect 12 includes: an accommodation portion configured to accommodate an electronic key; a pressing member configured to press a button of the electronic key accommodated in the accommodation portion; an actuator configured to apply power for pressing the button to the pressing member; a position setting portion configured to set a relative position between the actuator and the pressing member; and an intermediate member configured to transmit the power from the actuator to the pressing member, in which the intermediate member includes a first intermediate member and a second intermediate member, the position setting portion sets positions of a plurality of the pressing members along either a first direction or a second direction intersecting the first direction, the first intermediate member is configured to transmit the power to one of the plurality of pressing members, and the second intermediate member is configured to transmit the power to the other of the plurality of pressing members.

According to the above aspect, since the plurality of pressing members can be arranged in a row by the position setting portion while the position of the actuator is fixed, the positions of the plurality of pressing members and positions of a plurality of buttons of the electronic key can be easily matched. Accordingly, the electronic key operation device can be used by a minimal design change for various electronic keys.

1. An electronic key operation device comprising:
an accommodation portion configured to accommodate an electronic key;
a pressing member configured to press a button of the electronic key accommodated in the accommodation portion;
an actuator configured to apply power for pressing the button to the pressing member; and
a position setting portion configured to set a relative position between the actuator and the pressing member,
wherein the position setting portion is configured to set a position of the pressing member so as to correspond to a position of the button in a first direction and a second direction intersecting the first direction.

2. The electronic key operation device according to claim 1,
wherein the position setting portion includes a plurality of receiving portions for accommodating the pressing member.

3. The electronic key operation device according to claim 2,
wherein the pressing member is slidable in the receiving portion of the position setting portion, the button is capable of being pressed at one end of the pressing member, and the power for pressing the button is applied at another end thereof.

4. The electronic key operation device according to claim 1,
wherein at least two pressing members are provided, and
wherein the position setting portion includes at least a first portion and a second portion for setting positions of the pressing members, respectively.

5. The electronic key operation device according to claim 4,
wherein the first portion and the second portion of the position setting portion are adjacent to each other in both the first direction and the second direction.

6. The electronic key operation device according to claim 1, further comprising:
an intermediate member for transmitting the power from the actuator to the pressing member.

7. The electronic key operation device according to claim 6,
wherein the intermediate member includes a rotation shaft, and power from the actuator is transmitted to the pressing member by movement of the intermediate member in a circumferential direction.

8. The electronic key operation device according to claim 4, further comprising:
an intermediate member for transmitting power from the actuator to the pressing member,
wherein the intermediate member is divided into a first intermediate member and a second intermediate member corresponding to the first portion and the second portion of the position setting portion.

9. The electronic key operation device according to claim 8,
wherein the first intermediate member and the second intermediate member are adjacent to each other in both the first direction and the second direction.

10. The electronic key operation device according to claim 6,
wherein the position setting portion is a member separate from the intermediate member.

11. The electronic key operation device according to claim 1,
wherein the electronic key is accommodated in the accommodation portion in a state of being fixed by an electronic key accommodation case.

12. An electronic key operation device comprising:
an accommodation portion configured to accommodate an electronic key;
a pressing member configured to press a button of the electronic key accommodated in the accommodation portion;
an actuator configured to apply power for pressing the button to the pressing member;
a position setting portion configured to set a relative position between the actuator and the pressing member; and
an intermediate member configured to transmit the power from the actuator to the pressing member,
wherein the intermediate member includes a first intermediate member and a second intermediate member, and
wherein the position setting portion sets positions of a plurality of the pressing members along either a first direction or a second direction intersecting the first direction, the first intermediate member is configured to transmit the power to one of the plurality of pressing members, and the second intermediate member is configured to transmit the power to the other of the plurality of pressing members.
